(19) United States
(12) Patent Application Publication
(10) Pub. No.: US 2025/0074101 A1
(43) Pub. Date: Mar. 6, 2025

(54) EFFECT PIGMENT, MANUFACTURING METHOD, VALUABLE DOCUMENT AND PRINTING INK

(71) Applicant: GIESECKE+DEVRIENT CURRENCY TECHNOLOGY GMBH, Munchen (DE)

(72) Inventors: Kai Herrmann SCHERER, Munchen (DE); Christian STOCKL, Gmund a. Tegernsee (DE); Peter DREXLER, Fischbachau (DE); Maik Rudolf Johann SCHERER, Grainau (DE)

(21) Appl. No.: 18/293,957

(22) PCT Filed: Jul. 12, 2022
(86) PCT No.: PCT/EP2022/025326

§ 371 Date: Jan. 31, 2024

(30) Foreign Application Priority Data
Aug. 4, 2021 (DE) 10 2021 004 024.4

(51) Int. Cl. B42D 25/369; B41M 3/00; B41M 3/14; B41M 7/00; B42D 25/373; B42D 25/378; C09D 11/037; C09D 11/101; C09D 11/50

(52) U.S. Cl. CPC B42D 25/369; B41M 3/008; B41M 3/14; B41M 7/0081; B41M 7/009; B42D 25/378; C09D 11/037; C09D 11/101; C09D 11/50; B42D 25/373

(57) ABSTRACT

A platelet-shaped magnetic effect pigment for use in a printing ink, includes a layer construction with a magnetic layer and at least one optical functional layer. The magnetic layer is based on elongate nanomagnets that do not touch one another and have a substantially uniform preferred magnetic direction arranged perpendicular to the platelet plane of the effect pigment.

The invention relates to a platelet-shaped magnetic effect pigment for use in a printing ink. The invention further relates to a method for manufacturing the platelet-shaped magnetic effect pigment, to a printing ink containing the effect pigments and to a value document printed with the effect pigments.

Data carriers, such as value or identification documents, or other value objects, such as branded goods, are often safeguarded by being provided with security elements which allow the authenticity of the data carriers to be verified and which at the same time serve as protection against unauthorized reproduction. Security elements with viewing angle-dependent effects play a particular role in securing authenticity, since they are unable to be reproduced even with the most modern copying machines. These security elements are equipped with optically variable elements which convey a different visual impression to the viewer at different viewing angles and for example display another color or brightness impression and/or another graphic motif depending on the viewing angle.

Thin-layer systems which produce a viewing angle-dependent color impression for the viewer by means of interference are known in the prior art. This optical effect can serve as an optically variable security element. A large-area thin-layer system can be comminuted by means of various techniques. The size of the resulting flakes or platelets can laterally be up to a few micrometers, but the size mostly ranges from 2 μm to 100 μm. The vertical construction of a platelet is given by the requirements for the interference layers and is generally as thin as possible, for example in a range from 200 nm to 800 nm. Such platelets are used for example in optically variable ink (what is known as OVI® ink) which serves for the provision of a security element.

Also known is the option of applying the color impression-generating thin-layer systems to a ferromagnetic material. The pigment platelets thus have a magnetic moment. Magnetically orientable effect pigments are for example commercially available under the trade name OVMI® from SICPA (the abbreviation OMVI stands for the term “optically variable magnetic ink”). The pigments typically have a platelet-shaped construction and are in the form of a layer composite which often contains two layers of optical effect layers and a magnetic layer embedded in between. Suitable with respect to the optical effect layers are metallically reflective layers as well as color-shifting layer systems, for example with an absorber/dielectric/reflector construction. The embedded magnet layer is generally not visible but is necessary for the orientation of the pigments.

It is also known in the prior art to use such color pigments having a magnetic moment for the provision of optically variable security elements. For this purpose, the pigments are introduced into a transparent binder. An external magnetic field can be used to influence the orientation of the pigments immediately after the printing on a substrate. The binder is then cured for example by means of UV irradiation in order to fix the orientations of the pigments. By skillfully setting the spatial profile of the pigment orientations, it is possible to provide the printed substrate with optical movement effects. Since the magnetization direction of the pigments preferably runs along the direction of the greatest dimension of the pigments due to shape anisotropy, the magnetic moment of the particles is oriented perpendicular to the normal vector of the thin layers. If a magnetic field with a field strength with the symbol “H” is applied, the pigments are oriented such that their magnetic moments are as parallel as possible to the field vector.

As a consequence, the magnetic pigments can rotate about axes that are parallel to their magnetization and are arranged perpendicular to the normal vector of the thin layers. When the magnetic pigments are used as known in the prior art, it can be assumed that the orientation of the pigments is essentially uniform in one direction, while it is essentially randomly distributed in another direction. This results in an expansion of the light reflection and in a reduced brilliance and sharpness of the optically variable effect.

The object of the present invention is to provide magnetic effect pigments which enable more extensive control of the spatial orientation in order to thereby achieve a more attractive optical effect.

This object is achieved on the basis of the combinations of features defined in the independent claims.

Developments of the invention are the subject of the subclaims.

### SUMMARY OF THE INVENTION

1. (First aspect of the invention) A platelet-shaped magnetic effect pigment for use in a printing ink, comprising a layer construction with a magnetic layer and at least one optical functional layer, wherein the magnetic layer is based on elongate nanomagnets that do not touch one another and have a substantially uniform preferred magnetic direction arranged perpendicular to the platelet plane of the effect pigment.

2. (Preferred configuration) The platelet-shaped magnetic effect pigment according to clause 1, wherein the elongate nanomagnets are arranged spaced apart from one another in at least one plane that is horizontal to the platelet plane of the effect pigment, wherein the spacing corresponds at least to the diameter of the individual nanomagnets.

3. (Preferred configuration) The platelet-shaped magnetic effect pigment according to clause 1, wherein the elongate nanomagnets are arranged spaced apart from one another in two or more planes that lie one above the other and are each horizontal to the platelet plane of the effect pigment and the spacing between the elongate nanomagnets in relation to the respective plane corresponds at least to the diameter of the individual nanomagnets, wherein the elongate nanomagnets in in each case two planes lying one above the other are arranged with a horizontal offset in relation to the vertical.

4. (Preferred configuration) The platelet-shaped magnetic effect pigment according to any of clauses 1 to 3, wherein the diameter of the individual nanomagnets is selected in a range from 10 nm to 3 micrometers, wherein the range from 400 nm to 3 micrometers is preferred, and the length of the individual nanomagnets is selected in a range from 1 micrometer to 20 micrometers, wherein the range from 5 micrometers to 20 micrometers is preferred.

5. (Preferred configuration) The platelet-shaped magnetic effect pigment according to any of clauses 1 to 4, wherein the elongate nanomagnets have a hexagonal, honeycomb-like base or a quadrangular, chessboard square-like base.

6. (Preferred configuration) The platelet-shaped magnetic effect pigment according to any of clauses 1 to 5, wherein the material of the magnetic layer is selected from the group consisting of BaFe₁₂O₁₉, FePt, CoCrPt, CoPt, BiMn, α-Fe₂O₃, Nd₂Fe₁₄B, iron, cobalt, nickel or an alloy of one or more of the elements iron, cobalt and nickel.

7. (Preferred configuration) The platelet-shaped magnetic effect pigment according to any of clauses 1 to 6, wherein the optical functional layer is a metallic layer, a color layer obtainable by printing, an interference layer construction based on a reflective layer, a dielectric layer and an absorbing layer, or a combination of two or more of the abovementioned elements, for example a color layer obtainable by printing that is arranged above a metallic layer.

8. (Preferred configuration) The platelet-shaped magnetic effect pigment according to any of clauses 1 to 7, wherein the effect pigment has a sandwich-like layer construction and the magnetic layer as a central layer is provided both on the front side and on the rear side with in each case an optical functional layer, wherein the two optical functional layers are independently of one another selected from a reflective metallic layer, a color layer obtainable by printing, an interference layer construction based on a reflective layer, a dielectric layer and an absorbing layer, or a combination of two or more of the abovementioned elements, for example a color layer obtainable by printing that is arranged above a reflective metallic layer.

9. (Preferred configuration) The platelet-shaped magnetic effect pigment according to clause 8, wherein the effect pigment has an asymmetric layer construction with two optical functional layers that differ from one another, preferably two optical functional layers that differ from one another, are each an interference layer construction based on a reflective layer, a dielectric layer and an absorbing layer and in particular differ from one another in terms of the material or the layer thickness of the dielectric layer, and the effect pigment has the following layer sequence: absorbing layer—dielectric layer—reflective layer—magnetic layer—reflective layer—dielectric layer—absorbing layer.

10. (Preferred configuration) The platelet-shaped magnetic effect pigment according to clause 8, wherein the effect pigment has a symmetric layer construction with two identical optical functional layers.

11. (Preferred configuration) The platelet-shaped magnetic effect pigment according to clause 10, wherein the effect pigment has a symmetric layer construction, wherein the magnetic layer as a central layer is provided both on the front side and on the rear side with in each case an optical functional layer, wherein the two optical functional layers are each an interference layer construction based on a reflective layer, a dielectric layer and an absorbing layer and the effect pigment has the following layer sequence: absorbing layer—dielectric layer—reflective layer—magnetic layer—reflective layer—dielectric layer—absorbing layer.

12. (Preferred configuration) The platelet-shaped magnetic effect pigment according to clause 7, wherein the optical functional layer is an interference layer construction based on a reflective layer, a dielectric layer and an absorbing layer and the effect pigment has the following layer sequence: absorbing layer—dielectric layer—reflective layer—dielectric layer—absorbing layer—magnetic layer.

13. (Preferred configuration) The platelet-shaped magnetic effect pigment according to clause 9, wherein the effect pigment has an asymmetric layer construction, wherein the magnetic layer is provided on the front side with an interference layer construction based on a reflective layer, a dielectric layer and an absorbing layer and the magnetic layer is provided on the rear side with a reflective metallic layer, with the result that the effect pigment has the following layer sequence: absorbing layer—dielectric layer—reflective layer—magnetic layer—reflective metallic layer.

14. (Second aspect of the invention) A method for manufacturing a platelet-shaped magnetic effect pigment according to any of clauses 1 to 13, comprising
a) the production of a magnetic layer, wherein the magnetic layer is based on elongate nanomagnets that do not touch one another and have a substantially uniform preferred magnetic direction arranged perpendicular to the platelet plane of the effect pigment to be produced;
b) the production of a layer construction having the magnetic layer and at least one optical functional layer; and
c) the comminution of the layer construction obtained in step b) to form individual platelet-shaped magnetic effect pigments.

15. (Preferred configuration) The method according to clause 14, wherein in step a) the magnetic layer is produced on an embossing lacquer provided with an embossed relief, wherein the embossed relief is in particular provided with a honeycomb grid system or a chessboard grid system.

16. (Third aspect of the invention) A method for manufacturing a value document, comprising
the printing of the value document substrate in a first region with a first printing ink containing platelet-shaped magnetic effect pigments according to any of clauses 1 to 13;
the orientation of the platelet-shaped magnetic effect pigments in the first printing ink printed in each case in the first region by means of an external magnetic field;
the curing of the first printing ink printed in the first region.

17. (Preferred configuration) The method according to clause 16, comprising
the printing of the value document substrate in a first region with a first printing ink containing first platelet-shaped magnetic effect pigments as claimed in any of claims 1 to 13;
the printing of the value document substrate in a second region adjoining the first region with a second printing ink containing second platelet-shaped magnetic effect pigments as claimed in any of claims 1 to 13, wherein the second effect pigments are visually different from the first effect pigments;
the orientation of the platelet-shaped magnetic effect pigments in the first and second printing ink printed respectively in the first and in the second region by means of an external magnetic field;
the curing of the first and second printing ink printed respectively in the first and in the second region.

18. (Preferred configuration) The method according to clause 16, comprising
the printing of the value document substrate in a first region with a first printing ink containing platelet-shaped magnetic effect pigments according to any of clauses 1 to 13;
the printing of the value document substrate in a second region adjoining the first region with a second printing ink containing conventional, platelet-shaped magnetic effect pigments, wherein the conventional, platelet-shaped magnetic effect pigments have a preferred magnetic direction running along the platelet plane;
the orientation of the platelet-shaped magnetic effect pigments in the first and second printing ink printed respectively in the first and in the second region by means of an external magnetic field;
the curing of the first and second printing ink printed respectively in the first and in the second region, with the result that the two regions have an appearance clearly distinguishable from one another as a result of the different orientation of the two effect pigment types.

19. (Fourth aspect of the invention) A value document obtainable by the method according to any of clauses 16 to 18.

20. (Preferred configuration) The value document according to clause 19, wherein the value document is a banknote or an identification document.

21. (Fifth aspect of the invention) A printing ink comprising platelet-shaped magnetic effect pigments according to any of clauses 1 to 13.

22. (Preferred configuration) The printing ink according to clause 21, wherein the printing ink comprises a binder, preferably a UV-curing binder, an electron beam-curing binder or a heat-curing binder.

### DETAILED DESCRIPTION OF THE PREFERRED EMBODIMENTS

The present invention is based on the concept of using microstructuring of a magnetic material to produce individual, very small magnetic domains in the form of elongate, spaced-apart nanomagnets. The nanomagnets in particular have an acicular shape. The shape of the domains produced is such that a platelet-shaped effect pigment with a desired magnetic anisotropy in the direction perpendicular to the platelet plane is produced. It is crucial here that the individual, elongate nanomagnets do not touch one another, i.e. are spaced apart. In the case of two planes which are arranged one above the other and each plane of which has individual nanomagnets, it is crucial that the nanomagnets of the two planes are arranged offset from one another. In other words, the elongate nanomagnets of the two planes arranged one above the other are arranged with a horizontal offset with respect to the vertical. In this way, the shape anisotropy of the nanomagnets is not disrupted by a coherent macrostructure.

The elongate, spaced-apart nanomagnets are advantageously arranged in relation to the respective plane at a spacing that corresponds at least to the diameter of the individual nanomagnets. The diameter of the individual nanomagnets is suitably selected in a range from 10 nm to 3 micrometers, the range from 400 nm to 3 micrometers being preferred. The length of the elongate, spaced-apart nanomagnets is suitably selected in a range from 1 micrometer to 20 micrometers, the range from 5 micrometers to 20 micrometers being preferred.

The effect pigment according to the invention may be manufactured for example on the basis of a UV radiation-curing embossing lacquer. The embossing lacquer is advantageously provided with an embossed relief in the form of a honeycomb grid system or chessboard grid system, where, in the case of two planes which are arranged one above the other and each plane of which has individual nanomagnets, each honeycomb or each chessboard square is vertically distant from the surrounding honeycombs or chessboard squares at least by a spacing that corresponds at least to the magnet layer thickness or the length of the nanomagnets to be produced. The nanomagnets may advantageously be produced by vapor deposition. The elongate nanomagnets have for example the shape of a cylinder with a hexagonal, honeycomb-like base or with a quadrangular, chessboard square-like base, where the magnetic moment is arranged perpendicular to the base because the height of the nanomagnet is significantly greater than the diameter of the base.

The effect pigment according to the invention may also be manufactured in such a way that the individual, elongate nanomagnets are produced by means of vapor deposition, where the vapor deposition is effected by means of a mask. The mask provided with vacancies is structured in such a way that the elongate nanomagnets to be produced are arranged at a certain spacing from one another.

The magnetic material on which the elongate nanomagnets are based is in particular a ferromagnetic or ferrimagnetic material. The base magnetic material may for example be selected from the group consisting of BaFe₁₂O₁₉ or barium ferrite, FePt, CoCrPt, CoPt, BiMn or bismanol, α-Fe₂O₃ or hematite, and (particularly tetragonal) Nd₂Fe₁₄B.

The magnetic layer having the elongate nanomagnets may be combined on one side with an optical functional layer in order to thereby produce an optically variable magnetic layer construction. Alternatively, the magnetic layer may be combined on both sides with in each case an optical functional layer in order to thereby produce an optically variable magnetic layer construction.

A preferred layer construction is a symmetrical layer construction having for example the layer sequence of absorbing layer—dielectric layer—reflective layer—magnetic layer—reflective layer—dielectric layer—absorbing layer. In this layer construction, on both sides with respect to the central magnetic layer there is in each case a color-flopping coating based on an absorber/dielectric/reflector thin-layer system. The individual layers may for example be applied by means of vapor deposition under reduced pressure or applied by what is known as sputtering. Suitable as an absorbing layer is for example a Cr layer. The reflective layer may for example be formed by an Al layer. Suitable as a dielectric layer is for example an SiO₂ layer or a ZnS layer.

A further preferred layer construction has the layer sequence of absorbing layer—dielectric layer—reflective layer—dielectric layer—absorbing layer—magnetic layer. In this layer construction, the reflectivity or the degree of reflection of the layer construction is influenced on one side by the presence of the magnetic layer.

Instead of an interference coating or a color-flopping thin-layer system, it is further possible to use color layers obtainable by printing, preferably translucent color layers, and/or pure reflective layers or metallic layers as an optical functional layer.

Instead of a symmetric layer construction in which the color impression is independent of the viewing side, it is also possible to use an asymmetric layer construction. Since, according to the invention, the magnetic moment is in particular perpendicular to the layer plane, the visibilities of the top side and of the bottom side can be controlled in regions by means of external magnetic fields. In other words, use may be made of platelet-shaped magnetic effect pigments that have a fixed magnetic north side and south side but differ from one another with respect to the optical functional layer of these two sides. By way of example, it is possible to use optically variable magnetic effect pigments that simultaneously have different color-flopping effects on the top side and on the bottom side and the magnetic moment of which relative to the top side and bottom side is fixedly defined: north pole on the top side with the first color-flopping effect and south pole on the bottom side with the second color-flopping effect. If these pigments are printed on a transparent (value document) substrate and are oriented with an external magnetic field before the binder of the printing ink is cured, then the viewer always sees, from one side, the top side of the pigments with the first color-flopping effect and, from the other side, the bottom side of the pigments with the second color-flopping effect that differs from the first color-flopping effect.

Furthermore, the magnetic layer of the effect pigment according to the invention may for example be combined on one side or on both sides with (in each case) an optical functional layer, where the optical functional layer has a metallic layer, in particular a reflective metallic layer, and a glazing or translucent color layer. Appealing optical effects are achievable by means of a metallic layer arranged between the magnetic layer and the color layer.

The magnetic layer of the effect pigment according to the invention may for example also be combined on one side or on both sides with (in each case) an optical functional layer, where the optical functional layer has a dielectric layer, for example SiO₂, and a metallic layer, in particular a reflective metallic layer, for example Al. A combination of SiO₂ and Al makes it possible to achieve for example golden hues even without a further absorbing layer and without a further color layer.

There are various possibilities with regard to the manufacture of the pigments according to the invention. A feature common to all methods is that a layer construction is first produced above a carrier substrate, for example a carrier film such as a polyethylene terephthalate (PET) film, the layer construction having at least the magnetic layer and an optical functional layer. The layer construction is then detached from the carrier substrate and optionally comminuted, for example by means of grinding, until particles with an adequate size distribution are obtained. For this purpose, it is advantageous to arrange between the carrier substrate and the layer construction a further layer which is able to be removed in a controlled or selective manner, for example by dissolution in a suitable solvent. The effect pigments obtained may then be mixed with a UV-curing binder to form a (screen) printing ink. The effect pigments are in particular flat optically-variable pigments and preferably have a magnetic moment oriented perpendicular to the effect pigment plane, in accordance with the perpendicular orientation of the individual, elongate nanomagnets. In the step of applying the ink to a substrate such as a security paper or a value document substrate by printing, an external magnetic field is advantageously applied and the ink is cured, for example by UV radiation or by the action of heat, with the result that the effect pigments become immobile.

Numerous advantages can be realized by the platelet-shaped effect pigments according to the invention:
Novel optical effects can be achieved because the magnetic effect pigments according to the invention can be spatially oriented in a defined direction. This makes it possible to achieve optical effects such as flip effects which to date were only obtainable on the basis of what is known as micromirror technology, as described for example in WO 2007/079851 A1. The platelet-shaped effect pigments according to the invention enable a defined spatial orientation of each individual mirror, where the mirrors are each produced by a single magnetic, platelet-shaped effect pigment.
The magnetic platelet-shaped effect pigments according to the invention can be tilted in a defined manner, leading to particular technical advantages in connection with magnetic security elements. Magnetic security elements, namely magnetic coding elements made of magnetic grid strips, are described for example in WO 2014/161674 A1. The platelet-shaped effect pigments according to the invention that can be spatially oriented in a defined manner make it possible to achieve magnetic effects that open up many more coding possibilities than has been known to date in the prior art.
The magnetic platelet-shaped effect pigment according to the invention has a magnetic feature that is detectable using a suitable sensor. This is because the magnetic anisotropy can be measured, see for example WO 2014/161674 A1. Thus, in the case of a nanostructured magnet layer based on the magnetic pigments according to the invention, it is not the coercivity but rather the magnetic anisotropy that can be encoded by way of the nanostructuring and read in a location-specific manner by machine using a suitable sensor system.

The invention further relates to a method for manufacturing a value document, comprising
the printing of the value document substrate in a first region with a first printing ink containing platelet-shaped magnetic effect pigments according to the invention;
the orientation of the platelet-shaped magnetic effect pigments in the first printing ink printed in the first region by means of an external magnetic field;
the curing of the first printing ink printed in the first region.

In comparison with the effect pigments according to the prior art with a magnetization that runs in the plane of the effect pigment, the magnetic effect pigments according to the invention orient themselves in an externally applied magnetic field in such a way that the security feature resulting therefrom has a more brilliant effect and the light reflections appear smoother because less light is scattered in different directions. This optical effect is particularly advantageous in the case of a magnetization that runs perpendicular to the effect pigment plane.

A preferred method for manufacturing a value document comprises:
the printing of the value document substrate in a first region with a first printing ink containing first platelet-shaped magnetic effect pigments according to the invention;
the printing of the value document substrate in a second region adjoining the first region with a second printing ink containing second platelet-shaped magnetic effect pigments according to the invention, wherein the second effect pigments are visually different from the first effect pigments;
the orientation of the platelet-shaped magnetic effect pigments in the first and second printing ink printed respectively in the first and in the second region by means of an external magnetic field;
the curing of the first and second printing ink printed respectively in the first and in the second region.

Another preferred method for manufacturing a value document comprises:
the printing of the value document substrate in a first region with a first printing ink containing the platelet-shaped magnetic effect pigments according to the invention;
the printing of the value document substrate in a second region adjoining the first region with a second printing ink containing conventional, platelet-shaped magnetic effect pigments, wherein the conventional, platelet-shaped magnetic effect pigments have a preferred magnetic direction running along the platelet plane;
the orientation of the platelet-shaped magnetic effect pigments in the first and second printing ink printed respectively in the first and in the second region by means of an external magnetic field;
the curing of the first and second printing ink printed respectively in the first and in the second region, with the result that the two regions have an appearance clearly distinguishable from one another as a result of the different orientation of the two effect pigment types.

The distinctive jump in the appearance at the region boundaries that is due to the different optically variable properties of the regions with the different effect pigment types constitutes a striking and advantageous security feature.

Further advantages of the invention are elucidated hereinafter on the basis of exemplary embodiments in connection with highly schematically simplified figures, the representation of which dispenses with reproduction that is to scale and in proportion in order to increase clarity.

The figures show:

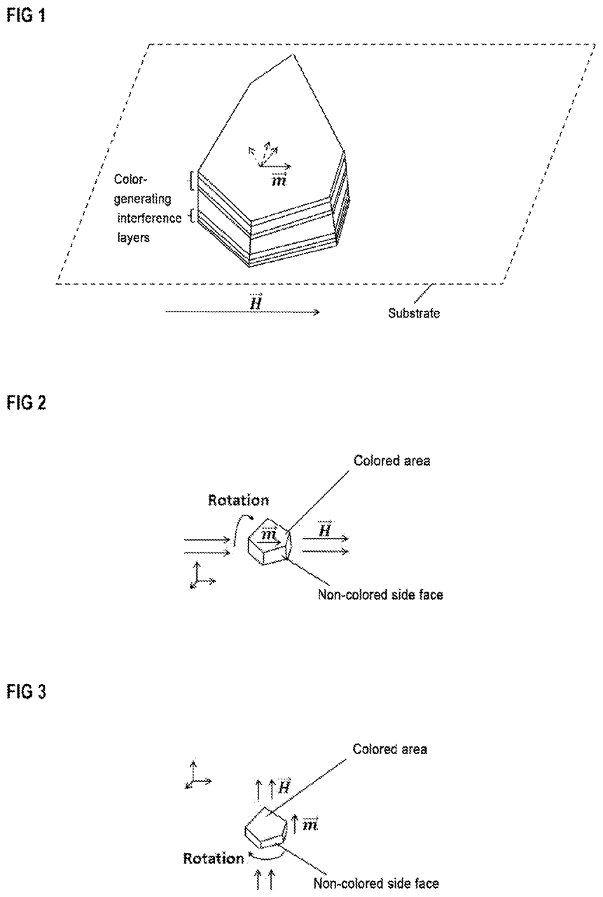

FIG. 1 the provision of an optically variable security element by means of a conventional platelet-shaped magnetic effect pigment according to the prior art, the magnetic moment of which (with the symbol “m”) runs perpendicular to the normal vector of the platelet plane; here, the pigments are introduced into a transparent binder and the printing ink produced is printed onto a substrate, the spatial orientation of the pigments being influenced by means of an external magnetic field immediately after the printing;

FIG. 2 a conventional platelet-shaped magnetic effect pigment according to the prior art, the magnetic moment of which (with the symbol “m”) runs perpendicular to the normal vector of the platelet plane; also shown are the possible orientations of the pigment in the magnetic field (with the symbol “H”) which come about by rotation about an axis;

FIG. 3 the rotation of an effect pigment according to the invention about the surface normal in the case of a magnetization that points parallel to the surface normal; the intensity of the optical reflection does not change here;

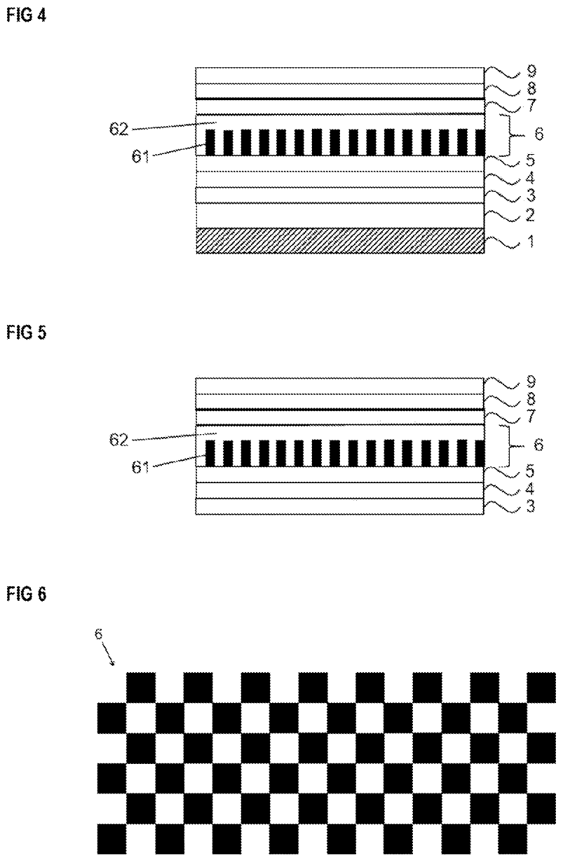

FIGS. 4-7 the manufacture of an effect pigment according to the invention in accordance with a first exemplary embodiment; and

FIGS. 8-13 the manufacture of an effect pigment according to the invention in accordance with a second exemplary embodiment.

It is known in the prior art to use platelet-shaped magnetic effect pigments for the provision of optically variable security elements. The pigments typically have a platelet-shaped construction and are in the form of a layer composite which often contains two layers of optical effect layers and a magnetic layer embedded in between. Suitable with respect to the optical effect layers are metallically reflective layers as well as color-shifting layer systems, for example with an absorber/dielectric/reflector construction. The embedded magnet layer is generally not visible but is necessary for the orientation of the pigments. The pigments are introduced into a transparent binder in order to produce a printing ink. An external magnetic field can be used to influence the orientation of the pigments immediately after the application of the printing ink on a substrate, for example a paper substrate, by printing (see FIG. 1). The binder is then cured for example by means of UV irradiation in order to fix the orientations of the pigments. By skillfully setting the spatial profile of the pigment orientations, it is possible to provide the printed substrate with optical movement effects. Since the magnetization direction of the pigments preferably runs along the direction of the greatest dimension of the pigments due to shape anisotropy, the magnetic moment of the particles is oriented perpendicular to the normal vector of the thin layers. If a magnetic field with a field strength with the symbol “H” is applied, the pigments are oriented such that their magnetic moments are as parallel as possible to the field vector. As a consequence, the magnetic pigments can rotate about axes that are parallel to their magnetization with the symbol “m” and are arranged perpendicular to the normal vector of the platelet plane. When the magnetic pigments are used as known in the prior art, it can be assumed that the orientation of the pigments is essentially uniform in one direction, while it is essentially randomly distributed in another direction. A colored area of the pigment therefore does not always point upward (see attached FIG. 2). This results in an expansion of the light reflection and in a reduced brilliance and sharpness of the optically variable effect.

FIG. 2 shows a conventional platelet-shaped magnetic effect pigment according to the prior art, the magnetic moment of which (with the symbol “m”) runs perpendicular to the normal vector of the platelet plane. The figure illustrates the possible orientations of the pigment in the magnetic field (with the symbol “H”) which come about by rotation about an axis.

FIG. 3 shows the rotation of an effect pigment according to the invention about the surface normal in the case of a magnetization that points parallel to the surface normal. Unlike in the case of the above pigments according to the prior art which are described in connection with FIGS. 1 and 2, the advantage of the effect pigment according to the invention is such that the intensity of the optical reflection does not change in the course of the rotation.

FIGS. 4 to 7 illustrate the manufacture of an effect pigment according to the invention in accordance with a first exemplary embodiment.

As per FIG. 4, a layer construction is first produced which has the following layers:
a carrier substrate 1, in the example a polyethylene terephthalate (PET) film;
a release layer 2;
an absorbing layer 3, in the example a Cr layer;
a dielectric layer 4, in the example an SiO₂ layer;
a reflective layer 5, in the example an Al layer;
elongate nanomagnets 61 that are arranged spaced apart from one another along a plane that is horizontal to the platelet plane of the effect pigment to be produced, where the spacing corresponds at least to the diameter of the individual nanomagnets; the elongate nanomagnets 61 are leveled after production by means of a transparent protective lacquer 62; the nanomagnets 61 and the transparent protective lacquer 62 together form a magnetic layer 6;
a reflective layer 7, in the example an Al layer;
a dielectric layer 8, in the example an SiO₂ layer;
an absorbing layer 9, in the example a Cr layer.

The layer sequence 3, 4 and 5 on the one hand and the layer sequence 7, 8 and 9 on the other hand each form a color-flopping thin-layer construction.

As per FIG. 2, the carrier substrate 1 including the release layer 2 is subsequently detached from the rest of the layer construction by means of separation winding.

FIG. 3 shows a plan view of the nature of the elongate nanomagnets 61. The elongate nanomagnets 61 illustrated in black each have a square base and are spaced apart from one another according to the pattern of a chessboard so that they do not touch one another.

The step of comminuting the layer construction shown in FIG. 2 is then effected to form individual, platelet-shaped effect pigments 10 (see FIG. 3). The effect pigments 10 are each illustrated in cross section in FIG. 3. The thickness of the effect pigments 10 obtained is consistent. Otherwise, the dimensions of the effect pigments 10 obtained, namely length and width, in other words the overall shape of the effect pigments when viewed in plan view, are inconsistent.

FIGS. 8 to 13 illustrate the manufacture of an effect pigment according to the invention in accordance with a second exemplary embodiment.

As per FIG. 8, a carrier substrate 11 is first provided, in the example a polyethylene terephthalate (PET) film. The carrier substrate 11 is provided with a release layer 12, above which is arranged a UV embossing lacquer 13. The UV embossing lacquer 13 has a mosaic-like embossed structure that corresponds in plan view to the chessboard shown in FIG. 6, where the black squares correspond to the nanomagnets to be produced in a lower plane and the white squares correspond to the nanomagnets to be produced in an upper plane.

As per FIG. 9, a next step involves the production of a color-flopping thin-layer system 14 which has, in the following order starting from the UV embossing lacquer 13, an absorbing layer (in the example a Cr layer), a dielectric layer (in the example an SiO₂ layer) and a reflective layer (in the example an Al layer).

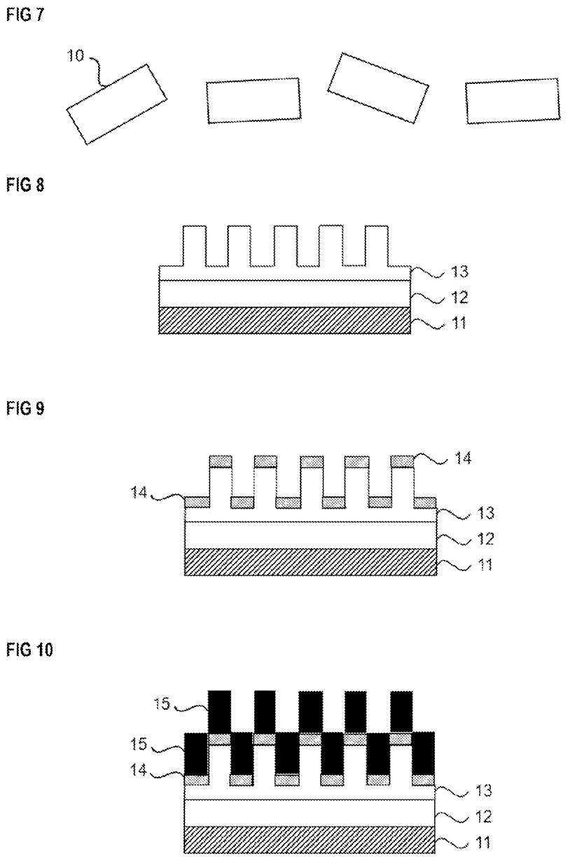

As per FIG. 10, the elongate nanomagnets 15 arranged both in a lower plane and in an upper plane are then produced. With respect to the respective plane, the elongate nanomagnets 15 are spaced apart from one another at a spacing that corresponds to the diameter of the nanomagnets. The elongate nanomagnets in the two planes lying one above the other are arranged with a horizontal offset with respect to the vertical.

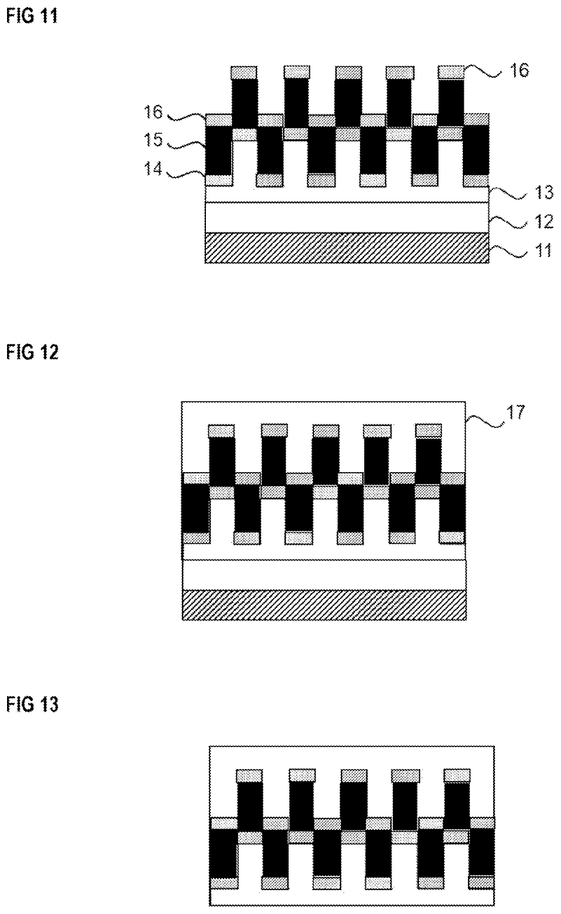

As per FIG. 11, a next step involves the production of a further color-flopping thin-layer system 16 which has, in the following order starting from the elongate nanomagnets 15, a reflective layer (in the example an Al layer), a dielectric layer (in the example an SiO₂ layer) and an absorbing layer (in the example a Cr layer).

As per FIG. 12, a leveling, transparent lacquer 17 is then applied.

As per FIG. 13, the carrier substrate 11 including the release layer 12 is subsequently detached from the rest of the layer construction by means of separation winding.

The step of comminuting the layer construction shown in FIG. 13 is then effected to form individual, platelet-shaped effect pigments.

1.-22. (canceled)

23. A platelet-shaped magnetic effect pigment for use in a printing ink, comprising a layer construction with a magnetic layer and at least one optical functional layer,
wherein the magnetic layer is based on elongate nanomagnets that do not touch one another and have a substantially uniform preferred magnetic direction arranged perpendicular to the platelet plane of the effect pigment.

24. The platelet-shaped magnetic effect pigment according to claim 23, wherein the elongate nanomagnets are arranged spaced apart from one another in at least one plane that is horizontal to the platelet plane of the effect pigment,
wherein the spacing corresponds at least to the diameter of the individual nanomagnets.

25. The platelet-shaped magnetic effect pigment according to claim 23, wherein the elongate nanomagnets are arranged spaced apart from one another in two or more planes that lie one above the other and are each horizontal to the platelet plane of the effect pigment and the spacing between the elongate nanomagnets in relation to the respective plane corresponds at least to the diameter of the individual nanomagnets,
wherein the elongate nanomagnets in in each case two planes lying one above the other are arranged with a horizontal offset in relation to the vertical.

26. The platelet-shaped magnetic effect pigment according to claim 23, wherein the diameter of the individual nanomagnets is selected in a range from 10 nm to 3 micrometers,
wherein the range from 400 nm to 3 micrometers, and the length of the individual nanomagnets is selected in a range from 5 micrometers to 20 micrometers.

27. The platelet-shaped magnetic effect pigment according to claim 23, wherein the elongate nanomagnets have a hexagonal, honeycomb-like base or a quadrangular, chessboard square-like base.

28. The platelet-shaped magnetic effect pigment according to claim 23, wherein the material of the magnetic layer is selected from the group consisting of BaFe12O19, FePt, CoCrPt, CoPt, BiMn, α-Fe2O3, Nd2Fe14B, iron, cobalt, nickel or an alloy of one or more of the elements iron, cobalt and nickel.

29. The platelet-shaped magnetic effect pigment according to claim 23, wherein the optical functional layer is a metallic layer, a color layer obtainable by printing, an interference layer construction based on a reflective layer, a dielectric layer and an absorbing layer, or a combination of two or more of the abovementioned elements, for example a color layer obtainable by printing that is arranged above a metallic layer.

30. The platelet-shaped magnetic effect pigment according to claim 23, wherein the effect pigment has a sandwich-like layer construction and the magnetic layer as a central layer is provided both on the front side and on the rear side within each case an optical functional layer,
wherein the two optical functional layers are independently of one another selected from a reflective metallic layer, a color layer obtainable by printing, an interference layer construction based on a reflective layer, a dielectric layer and an absorbing layer, or a combination of two or more of the abovementioned elements, for example a color layer obtainable by printing that is arranged above a reflective metallic layer.

31. The platelet-shaped magnetic effect pigment according to claim 30, wherein the effect pigment has an asymmetric layer construction with two optical functional layers that differ from one another, two optical functional layers that differ from one another, are each an interference layer construction based on a reflective layer, a dielectric layer and an absorbing layer and in particular differ from one another in terms of the material or the layer thickness of the dielectric layer, and the effect pigment has the following layer sequence: absorbing layer—dielectric layer—reflective layer—magnetic layer—reflective layer—dielectric layer—absorbing layer.

32. The platelet-shaped magnetic effect pigment according to claim 30, wherein the effect pigment has a symmetric layer construction with two identical optical functional layers.

33. The platelet-shaped magnetic effect pigment according to claim 32, wherein the effect pigment has a symmetric layer construction,
wherein the magnetic layer as a central layer is provided both on the front side and on the rear side within each case an optical functional layer,
wherein the two optical functional layers are each an interference layer construction based on a reflective layer, a dielectric layer and an absorbing layer and the effect pigment has the following layer sequence: absorbing layer—dielectric layer—reflective layer—magnetic layer—reflective layer—dielectric layer—absorbing layer.

34. The platelet-shaped magnetic effect pigment according to claim 29, wherein the optical functional layer is an interference layer construction based on a reflective layer, a dielectric layer and an absorbing layer and the effect pigment has the following layer sequence: absorbing layer—dielectric layer—reflective layer—dielectric layer—absorbing layer—magnetic layer.

35. The platelet-shaped magnetic effect pigment according to claim 31, wherein the effect pigment has an asymmetric layer construction,
wherein the magnetic layer is provided on the front side with an interference layer construction based on a reflective layer, a dielectric layer and an absorbing layer and the magnetic layer is provided on the rear side with a reflective metallic layer, with the result that the effect pigment has the following layer sequence: absorbing layer—dielectric layer—reflective layer—magnetic layer—reflective metallic layer.

36. A method for manufacturing a platelet-shaped magnetic effect pigment according to claim 23, comprising:
a) the production of a magnetic layer, wherein the magnetic layer is based on elongate nanomagnets that do not touch one another and have a substantially uniform preferred magnetic direction arranged perpendicular to the platelet plane of the effect pigment to be produced;
b) the production of a layer construction having the magnetic layer and at least one optical functional layer; and
c) the comminution of the layer construction obtained in step b) to form individual platelet-shaped magnetic effect pigments.

37. The method according to claim 36, wherein in step a) the magnetic layer is produced on an embossing lacquer provided with an embossed relief,
wherein the embossed relief is in particular provided with a honeycomb grid system or a chessboard grid system.

38. A method for manufacturing a value document, comprising:
the printing of the value document substrate in a first region with a first printing ink containing platelet-shaped magnetic effect pigments according to claim 23;
the orientation of the platelet-shaped magnetic effect pigments in the first printing ink printed in each case in the first region by means of an external magnetic field;
the curing of the first printing ink printed in the first region.

39. The method according to claim 38, comprising:
the printing of the value document substrate in a first region with a first printing ink containing first platelet-shaped magnetic effect pigments;
the printing of the value document substrate in a second region adjoining the first region with a second printing ink containing second platelet-shaped magnetic effect pigments,
wherein the second effect pigments are visually different from the first effect pigments;
the orientation of the platelet-shaped magnetic effect pigments in the first and second printing ink printed respectively in the first and in the second region by means of an external magnetic field;
the curing of the first and second printing ink printed respectively in the first and in the second region.

40. The method according to claim 38, comprising:
the printing of the value document substrate in a first region with a first printing ink containing platelet-shaped magnetic effect pigments;
the printing of the value document substrate in a second region adjoining the first region with a second printing ink containing conventional, platelet-shaped magnetic effect pigments,
wherein the conventional, platelet-shaped magnetic effect pigments have a preferred magnetic direction running along the platelet plane;
the orientation of the platelet-shaped magnetic effect pigments in the first and second printing ink printed respectively in the first and in the second region by means of an external magnetic field;
the curing of the first and second printing ink printed respectively in the first and in the second region, with the result that the two regions have an appearance clearly distinguishable from one another as a result of the different orientation of the two effect pigment types.

41. A value document obtainable by the method according to claim 38.

42. The value document according to claim 41, wherein the value document is a banknote or an identification document.

43. A printing ink comprising platelet-shaped magnetic effect pigments according to claim 23.

44. The printing ink according to claim 43, wherein the printing ink comprises a binder, including a UV-curing binder, an electron beam-curing binder or a heat-curing binder.
